(19) United States
(12) Patent Application Publication
(10) Pub. No.: US 2026/0361145 A1
(43) Pub. Date: Nov. 12, 2026

(54) AUTHENTICATION IN A WIRELESS POWER SYSTEM

(71) Applicants: DOLBY INTELLECTUAL PROPERTY LICENSING, LLC; GE INTELLECTUAL PROPERTY LICENSING, LLC, Niskayuna, NY (US)

(72) Inventors: VISWANATHAN KANAKASABAI, Bengaluru (IN); JAYANTI GANESH, Bengaluru (IN); SUBBARAO TATIKONDA, Bengaluru (IN)

(73) Assignee: DOLBY INTELLECTUAL PROPERTY LICENSING, LLC, (US)

(21) Appl. No.: 19/470,250

(22) PCT Filed: Mar. 28, 2024
(86) PCT No.: PCT/US2024/021861

§ 371 Date: Sep. 29, 2025

(30) Foreign Application Priority Data
Mar. 30, 2023 (IN) 202311023953

(51) Int. Cl. H02J 50/80; H02J 7/47; H02J 50/12

(52) U.S. Cl. CPC H02J 50/80; H02J 7/47; H02J 50/12

(57) ABSTRACT

This disclosure provides systems, methods and apparatuses for managing authentication in a wireless power system. Each wireless power apparatus (such as a Power Transmitter and a Power Receiver) might implement an authentication of the other wireless power apparatus. In some implementations, one or both of the wireless power apparatuses can abbreviate or omit a subsequent authentication of the other wireless power apparatus after a first successful authentication. For example, a first wireless power apparatus can store first identification information associated with a second wireless power apparatus in a local memory of the first wireless power apparatus after successfully authenticating the second wireless power apparatus. Later, when the first wireless power apparatus detects the second wireless power apparatus and receives the same first identification information from the second wireless power apparatus, the first wireless power apparatus can refrain from performing a further authentication of the second wireless power apparatus.

### RELATED APPLICATIONS

This application claims priority benefit of India Provisional Application No. 202311023953, filed Mar. 30, 2023, entitled “AUTHENTICATION IN A WIRELESS POWER SYSTEM” and assigned to the assignee hereof. The disclosure of the aforementioned application is considered part of and is incorporated by reference in this Patent Application.

### TECHNICAL FIELD

This disclosure relates generally to wireless power and some aspects relate to a managing authentication in a wireless power system.

### DESCRIPTION OF RELATED TECHNOLOGY

A wireless power system includes a Power Transmitter (PTx, sometimes also referred to as a wireless power transmission apparatus) and a Power Receiver (PRx, sometimes also referred to as a wireless power reception apparatus). The Power Transmitter includes a primary coil that produces an electromagnetic field during a power state to induce a voltage in a secondary coil of the Power Receiver when the secondary coil is placed in an electromagnetic field of the primary coil. The induced voltage can generate power for a load or for use by a rectifier that powers the load. Thus, the Power Transmitter can wirelessly transfer power to the Power Receiver using inductive coupling between the primary coil and the secondary coil. An appliance can use the power from the Power Receiver to operate a load (such as a motor, a heating element, electronics, or a power storage device, among other examples).

A wireless power system can include components from different manufacturers. For example, the manufacturer of a Power Receiver might be different from the manufacturer of a Power Transmitter. The manufacturers might implement a common specification so that the respective wireless power apparatuses are compatible. The common specification might specify communication protocols, circuit designs, and wireless power features. Manufacturers might undertake a manufacturer registration and product testing to ensure proper implementation of the specification. Authentication can enable a wireless power apparatus to verify that another wireless power apparatus is from a manufacturer that has registered and that the other wireless power apparatus has undergone product testing. Thus, authentication can be a tool to verify that another wireless power apparatus is compatible with the common specification. A wireless power apparatus that cannot be authenticated might be produced by a manufacturer that does not fully support the features of the specification. An unauthenticated wireless power apparatus can potentially cause damage to another wireless power apparatus. Current techniques for authentication of a wireless power apparatus are geared towards a use case that might not apply to all types of wireless power apparatuses or deployment scenarios.

### BRIEF SUMMARY

The systems, methods, and apparatuses of this disclosure each have several innovative aspects, no single one of which is solely responsible for the desirable attributes disclosed herein.

In one aspect, a method performed by a first wireless power apparatus. The method includes detecting a second wireless power apparatus. The method includes attempting an authentication of the second wireless power apparatus using a first authentication message exchange if the first wireless power apparatus has not successfully previously authenticated the second wireless power apparatus. The method includes refraining from the first authentication message exchange and proceeding with a wireless power transfer protocol if the first wireless power apparatus has successfully previously authenticated the second wireless power apparatus.

In one aspect, a method performed by a first wireless power apparatus. The method includes detecting a second wireless power apparatus at a first time. The method includes obtaining first identification information associated with a second wireless power apparatus. The method includes authenticating the second wireless power apparatus by verifying authentication information associated with the second wireless power apparatus. The method includes storing the first identification information in a local storage of the first wireless power apparatus after a first successful authentication of the second wireless power apparatus. The method includes refraining from at least one subsequent authentication of the second wireless power apparatus when the first wireless power apparatus detects the second wireless power apparatus at a second time.

In one aspect, a first wireless power apparatus includes a power transfer coil configured to transmit or receive wireless power from a second wireless power apparatus. The first wireless power apparatus also includes a controller configured to detect a second wireless power apparatus, attempting an authentication of the second wireless power apparatus using a first authentication message exchange if the first wireless power apparatus has not successfully previously authenticated the second wireless power apparatus, and refrain from the first authentication message exchange and proceeding with a wireless power transfer protocol if the first wireless power apparatus has successfully previously authenticated the second wireless power apparatus.

In one aspect, a first wireless power apparatus includes a power transfer coil configured to transmit or receive wireless power from a second wireless power apparatus. The first wireless power apparatus also includes a controller configured to detect a second wireless power apparatus at a first time, obtain first identification information associated with a second wireless power apparatus, authenticate the second wireless power apparatus by verifying authentication information associated with the second wireless power apparatus, store the first identification information in a local storage of the first wireless power apparatus after a first successful authentication of the second wireless power apparatus, and refrain from at least one subsequent authentication of the second wireless power apparatus when the first wireless power apparatus detects the second wireless power apparatus at a second time.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE SEVERAL VIEWS OF THE DRAWINGS

Like reference numbers and designations in the various drawings indicate like elements. Note that the relative dimensions of the figures may not be drawn to scale.

FIG. 1 illustrates an example wireless power system that includes a Power Transmitter and a Power Receiver.

FIG. 2 illustrates a state diagram of a wireless power system.

FIG. 3 illustrates a message diagram between a Power Transmitter and a Power Receiver in accordance with some aspects of this disclosure.

FIG. 4 illustrates a message diagram illustrating PKI-based authentication.

FIG. 5 illustrates an example authentication between the Power Transmitter and the Power Receiver.

FIG. 6 illustrates a flow chart with example operations of a first wireless power apparatus in accordance with some aspects of this disclosure.

FIG. 7 illustrates another flow chart with example operations of a first wireless power apparatus in accordance with some aspects of this disclosure.

FIG. 8 illustrates a flow chart with example operations of a first wireless power apparatus in accordance with some aspects of this disclosure.

FIG. 9 illustrates a block diagram of an example apparatus for use in a wireless power system.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system includes wireless power apparatuses, such as a Power Transmitter (PTx, sometimes also referred to as a wireless power transmission apparatus) and a Power Receiver (PRx, sometimes also referred to as a wireless power reception apparatus). In some implementations, the Power Transmitter may include a countertop-mounted primary coil or a primary coil that is embedded or manufactured in a surface on which a Power Receiver can be placed. A Power Receiver can be configured to wirelessly receive power from the Power Transmitter. Some examples of this disclosure are based on a kitchen environment. For example, the Power Transmitter might be part of a kitchen equipment such as a hob, a countertop, or range, while the Power Receiver might be part of a cordless appliance such as a cordless blender, kettle, toaster, or cooking vessel, among other examples. Each wireless power apparatus (such as the Power Transmitter or the Power Receiver) might have a capability to authenticate the other wireless power apparatus (the other of the Power Transmitter or the Power Receiver), and vice versa. An authentication typically involves messaging, which can be referred to as an authentication message exchange. For example, the authentication message exchange can include the communication of a key, a certificate digest, a challenge, a response, or any combination thereof. Furthermore, in some implementations, each authentication might be a bi-directional authentication such that each wireless power apparatus can authenticate the other wireless power apparatus. Because authentication includes an authentication message exchange, the authentication introduces communication overhead and latency to a wireless power protocol. In some environments, the wireless power apparatuses are often reused at the same location. For example, in a kitchen environment, the wireless power apparatuses might remain in the same location and be used with each other several times. Therefore, after the wireless power apparatuses have been authenticated for a first time, there is a possibility of simplifying or avoiding a subsequent authentication between those wireless power apparatuses the next time those wireless power apparatuses are used together.

This disclosure provides systems, methods and apparatuses for managing authentication in a wireless power system. Using the techniques of this disclosure, one or both of the wireless power apparatuses can abbreviate or omit a subsequent authentication of the other wireless power apparatus after a first successful authentication of the other wireless power apparatus. In some implementations, a first wireless power apparatus can store first identification information associated with a second wireless power apparatus in a local memory of the first wireless power apparatus after the first wireless power apparatus successfully authenticates the second wireless power apparatus. The stored identification information can be stored in non-volatile memory and serve as a persistent indication that the second wireless power apparatuses has been successfully previously authenticated. Later, when the first wireless power apparatus detects the second wireless power apparatus and receives the same first identification information from the second wireless power apparatus, the first wireless power apparatus can refrain from performing a further authentication of the second wireless power apparatus.

In some implementations, the first wireless power apparatus can periodically or randomly reauthenticate the second wireless power apparatus. For example, the first wireless power apparatus can reauthenticate the second wireless power apparatus after a threshold period following a successful previous authentication. In another example, the first wireless power apparatus can randomly reauthenticate the second wireless power apparatus after detecting the second wireless power apparatus at different times while avoiding reauthentication for other times.

In some implementations, an authentication can include an authentication message exchange to verify that the second wireless power apparatus is in possession of a private key issued by a trusted authority. For example, the trusted authority might include a central node or machine that distributes public and private keys as part of a public key infrastructure (PKI). The authentication message exchange also might include a challenge and response using PKI-based authentication. In some implementations, the private key and one or more root public keys might be stored in a secure memory that is attached, affixed, or integrated, with the wireless power apparatuses.

In some implementations, when an authentication fails, the first wireless power apparatus can implement a limitation on the wireless power transfer between the first wireless power apparatus and the second wireless power apparatus. For example, the limitation can include no power or limited power (limited to a maximum power rating). In some implementations, when the first wireless power apparatus fails to authenticate the second wireless power apparatus, the first wireless power apparatus can present (or cause presentation) of an error indication via a user interface of the first wireless power apparatus or the second wireless power apparatus.

Because some environments (such as a kitchen) can produce a harsh environment for some kitchen equipment or cordless appliance, it is possible that authentication information can become corrupt or unusable. Thus, in some implementations, the first wireless power apparatus can receive a user override and remove a limitation that would otherwise be implemented for the second wireless power apparatus after a failure to authenticate. For example, the error message can indicate that the user override requires a user to assume responsibility for damage that might occur as a result of wireless power transfer to an unauthenticated wireless power apparatus.

In some implementations, an authentication can be eliminated or avoided when one or more manufacturers implement an alternative solution for authenticating wireless power apparatuses. For example, one or more manufacturers can implement a non-standardized message exchange to verify the authenticity of a wireless power apparatus from a specific manufacturer. In some implementations, the one or more manufacturers might agree to use a handshake communication, secret key, or other data shared between the wireless power apparatuses to authenticate a wireless power apparatus from a specific manufacturer. For example, the non-standardized message exchange can be a proprietary solution that achieves authentication of a wireless power apparatus from a specific manufacturer without the use of a PKI-based authentication or the authentication message exchange of the wireless power specification.

Particular implementations of the subject matter described in this disclosure can be implemented to realize one or more of the following potential advantages. A one-time authentication (potentially including a bi-directional authentication) can ensure that a detected wireless power apparatus is certified by a trusted authority and reliably confirmed to implement a wireless power specification. Use of certified wireless power apparatuses can reduce the occurrence of damage that otherwise might result from a wireless power apparatus that has not been certified to comply with the wireless power specification. The techniques of this disclosure obtain the advantages of authentication while also reducing or eliminating the occurrence of subsequent authentications between the same pair of wireless power apparatuses. By reducing latency and communication overhead for the subsequent authentications, the disclosed techniques can improve user experience and confidence when using the wireless power apparatuses.

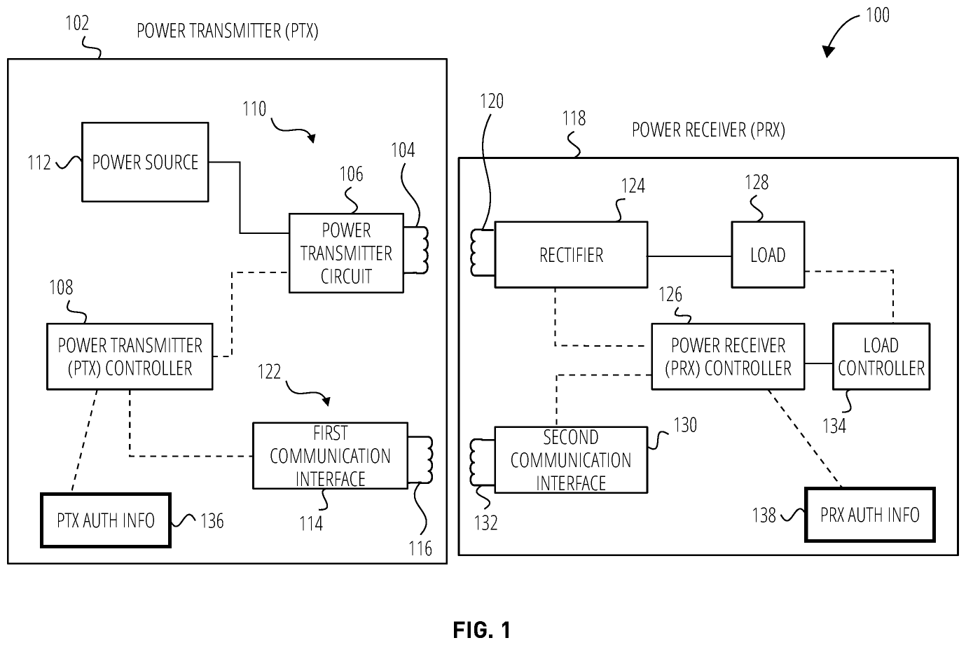

FIG. 1 illustrates an example wireless power system 100 that includes a Power Transmitter 102 and a Power Receiver 118. In FIG. 1, dashed lines represent communications to distinguish from solid lines that represent electrical circuit lines.

The Power Transmitter 102 and the Power Receiver 118 are two types of wireless power apparatuses that are used together. The Power Transmitter 102 includes a primary coil 104 and a Power Transmitter (PTx) controller 108. The primary coil 104 may be associated with a power transmitter circuit 106 (sometimes also referred to as a power signal generator or a driver circuit). The primary coil 104 may be a wire coil which transmits wireless power (which also may be referred to as wireless energy). The primary coil 104 may transmit wireless energy using an inductive or a resonant magnetic field. The power transmitter circuit 106 may include components (not shown) to prepare the wireless power. For example, the power transmitter circuit 106 may include one or more switches, drivers, series capacitors, rectifiers, inverters, or other components. In some implementations, the power transmitter circuit 106, PTx controller 108 and other components (not shown) may be collectively referred to as a Power Transmitter unit 110. Some or all of the Power Transmitter unit 110 may be embodied as an integrated circuit (IC) that implements features of this disclosure for controlling and transmitting wireless power to one or more wireless power reception apparatuses. The PTx controller 108 may be implemented as a microcontroller, dedicated processor, integrated circuit, application specific integrated circuit (ASIC) or any other suitable electronic device.

A power source 112 provides power to the Power Transmitter unit 110. In some implementations, the power source 112 may convert alternating current (AC) power to direct current (DC) power. For example, the power source 112 may include a converter that receives an AC power from an external power supply and converts the AC power to a DC power used by the power transmitter circuit 106. Alternatively, or additionally, a component (such as an inverter) of the power transmitter circuit 106 may convert the DC power to the AC power. The power source 112 may be integrated as part of the Power Transmitter 102 or may be external to the Power Transmitter 102.

In some implementations, the Power Transmitter 102 causes the power source 112 to regulate the DC output voltage of the power source 112. For example, the PTx controller 108 can set DC voltage of the power source 112 based on information (such as a value indicating a requested power) received from the Power Receiver 118. The Power Transmitter 102 can receive power configuration information from the Power Receiver 118 and use the information to set a parameter (such as the DC output voltage of the power source 112). The Power Transmitter 102 can receive the power configuration information during various operating states, such as the discovery state or power state. In some implementations, the Power Transmitter 102 includes a DC-DC converter (not shown) between the power source 112 and the Power Transmitter circuit 106 to control the variable DC output voltage.

The PTx controller 108 is connected to a first communication interface 114. The first communication interface 114 is connected to a first communication coil 116. In some implementations, the first communication interface 114 and the first communication coil 116 may be collectively referred to as the first communication unit 122. In some implementations, the first communication unit 122 may support Near-Field Communication (NFC). NFC is a technology by which data transfer occurs on a carrier frequency of 13.56 Megahertz (MHz). In some implementations, the first communication unit 122 may support Bluetooth (BT) communications. The first communication unit 122 also may support any suitable communication protocol. The first communication unit 122 may contain modulation and demodulation circuits to wirelessly communicate via the first communication coil 116. Alternatively, or additionally, the TX controller 108 may use frequency modulation to communicate via an in-band communication link (not shown) that includes the primary coil 104.

The Power Receiver 118 may include a secondary coil 120, a rectifier 124, a Power Receiver (PRx) controller 126, a second communication interface 130, a load controller 134, a load 128, and a memory (not shown). In some implementations, the load 128 can include a drive (not shown) for controlling at least one parameter such as charging current, speed, or torque of the load. In some implementations, the rectifier 124 may be omitted such as when the voltage induced in the secondary coil 120 can directly power the load 128. In some implementations, a series switch (not shown) may be included in series with the secondary coil 120 or in series between the rectifier 124 and the load 128. Although not shown, a load capacitance can be used after the rectifier 124 to reduce the rate of rise of load voltage that would otherwise occur when the load 128 suddenly reduces power consumption. Although shown as different components, some components may be packaged or implemented in the same hardware. For example, in some implementations, the PRx controller 126 and the load controller 134 may be implemented as a single controller. The PRx controller 126, the load controller 134, or any combination thereof, may be implemented as a microcontroller, dedicated processor, integrated circuit, application specific integrated circuit (ASIC) or any other suitable electronic device.

The PTx controller 108 may detect the presence or proximity of a Power Receiver 118. This detection may happen during a periodic pinging process of the first communication interface 114. During the pinging process, the first communication interface 114 also may supply power to the second communication interface 130 when the Power Receiver 118 is in proximity to the Power Transmitter 102. The second communication interface 130 may “wake up” and power-up the PRx controller 126 and may send a reply signal back to the first communication interface 114. Prior to power transfer, a handshaking process may take place during which the PTx controller 108 may receive identification and configuration data, among other information, from the Power Receiver 118. The PTx controller 108 may control characteristics of wireless power it provides to the Power Receiver 118 based on the configuration data.

A PRx controller 126 may be operationally coupled to the rectifier 124 and the second communication interface 130. The second communication interface 130 may contain modulation and demodulation circuits to wirelessly communicate via the second communication coil 132. Thus, the PRx controller 126 may wirelessly communicate feedback information to the PTx controller 108 via the second communication interface 130 to the first communication interface 114 using NFC communications. Alternatively, or additionally, the PRx controller 126 may use load modulation to communicate via an in-band communication link (not shown) that includes the secondary coil 120.

A load controller 134 may be operationally coupled to the load 128 and the second communication interface 130. The load controller 134 may detect changes to load states such as change in charging currents in a battery charging application.. The load controller 134 also may determine a load voltage reference. The load controller 134 also may send load voltage references, load current, and any other suitable information to the PRx controller 126 or the second communication interface 130 for communication to the Power Transmitter 102. The PRx controller 126 may additionally determine and provide feedback information indicating a measured load voltage available to the load 128. In some feedback messages, the feedback information may include a reference voltage indicating a required voltage for the load 128. In some feedback messages, the feedback information may indicate an error in the output voltage of the load 128. In some feedback messages, the feedback information may include the required power for the load. Although the PRx controller 126 and load controller 134 are shown separately, they may be included in the same component of the Power Receiver 118.

In some implementations, the Power Transmitter 102, the Power Receiver 118, or both, may be configured to authenticate the other of the Power Transmitter 102 or the Power Receiver 118. One type of authentication is referred to as a bi-directional authentication. In a bi-directional authentication, the Power Transmitter 102 authenticates the Power Receiver 118 and the Power Receiver 118 authenticates the Power Transmitter 102.

Each authentication (or bi-directional authentication) includes an authentication message exchange to verify that the other wireless power apparatus is certified to comply with a wireless power specification. In some implementations, authentication includes authentication messaging well known to persons of skill in the art of PKI-based authentication. For example, a trusted authority can issue authentication information (such as a private key) to a certified wireless power apparatus. The private key has a corresponding public key. The public key or a root public key can be provided to any wireless power apparatuses configured to authenticate another wireless power apparatus. Using the authentication message exchange, a wireless power apparatus (such as the Power Transmitter 102 or the Power Receiver 118) can verify that the other wireless power apparatus is in possession of a private key issued by the trusted authority. Although this disclosure describes PKI-based authentication as one type of authentication, other types of authentications (and their respective protocol for authentication message exchange) can be used for authentication of a wireless power apparatus.

In some implementations, authentication information (such as a private key and one or more public keys) can be securely stored, affixed, attached, integrated, or otherwise non-removable within a wireless power apparatus. For example, the Power Transmitter 102 might include PTX authentication information 136 stored in a secured manner such that the PTX authentication information 136 cannot be removed or becomes unusable if not used with the PTx controller 108 or other components of the Power Transmitter 102. Similarly, the Power Receiver 118 can include PRX authentication information 138 that is securely stored, affixed, attached, integrated, or otherwise non-removable within the Power Receiver 118.

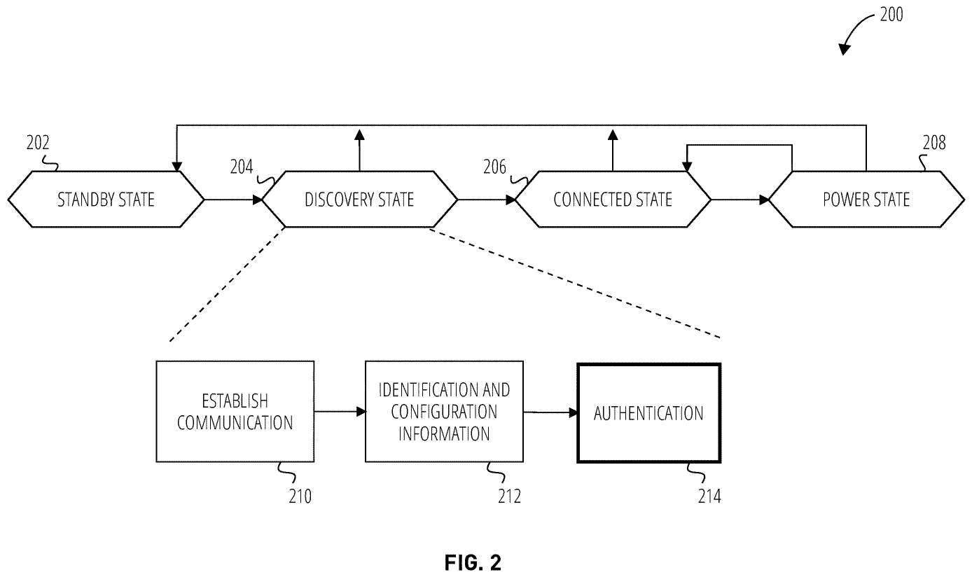

FIG. 2 illustrates a state diagram 200 of a wireless power system. The state diagram 200 illustrates the operating states in which the wireless power system may operate. When a Power Receiver is placed within an operating volume on the interface surface of a Power Transmitter, the two start to communicate with the aim to configure and control the power transfer. There can be four operating states associated with the wireless power system: a standby state 202 (sometimes also referred to as a ping state), a discovery state 204 (sometimes referred to as a configuration state), a connected state 206, and a power state 208 (sometimes referred to as a power transfer state). A technical specification may define how the Power Transmitter and Power Receiver can transition between the operating states. For example, the wireless power system typically begins in the standby state 202 until the Power Transmitter detects a Power Receiver, moving it to the discovery state 204. In the discovery state 204 the Power Transmitter establishes communication and receives the first identification information of the Power Receiver and its static configuration data. In the connected state 206 and the power state 208, the Power Transmitter and Power Receiver exchange information to agree and adjust parameters related to wireless power transfer. The system can move to a reinitialization state (not shown) as needed to reinitialize or return to the standby state when communication, powering, or other activities are no longer taking place. Each of the operating states are briefly described herein for reference.

In the standby state 202, the Power Transmitter tries to establish communications with a Power Receiver. The Power Receiver may be just placed on the interface surface or may not be present during this operating state. The Power Transmitter may attempt to communicate or detect the presence of the Power Receiver. For example, the Power Transmitter may use an analog ping, out-of-band communication (such as NFC), a digital ping, or any combination thereof, to determine that a compatible Power Receiver is present. Once the wireless power system determines that a Power Receiver is present (such as by confirming NFC communication), the wireless power system may transition to the discovery state 204.

In the discovery state 204, the Power Receiver may establish communication 210 with the Power Transmitter and send static configuration information (such as identification and configuration information 212) to the Power Transmitter. For example, the Power Transmitter may retrieve static configuration information from the Power Receiver via the NFC communication. The Power Transmitter and the Power Receiver may use this information to verify that they both use compatible versions of a technical specification or protocol for wireless power transfer. The Power Transmitter and Power Receiver may communicate basic settings or communicate regarding their respective capabilities. From the discovery state 204, the wireless power system may transition to the connected state 206.

In the connected state 206, the Power Transmitter and the Power Receiver may exchange further communications to negotiate the parameters that govern the power state. For example, a power negotiation can occur during the connected state 206. After negotiating the parameters, the Power Transmitter may be prepared to transfer wireless power and the Power Receiver may be prepared to receive the wireless power. However, the Power Transmitter may wait for a request or command from the Power Receiver before transitioning to the power state 208. This may be useful, for example, when a cordless appliance (such as a blender, toaster, mixer, or microwave, among other examples) is configured for use pending a user interaction. The user may initiate the power state 208 by a user interface (such as an activation switch) of the Power Receiver, which in turn communicates to the Power Transmitter to transition to the power state 208.

This disclosure describes an authentication procedure that might occur during the discovery state 204 or the connected state 206. For brevity, FIG. 2 shows the authentication 214 occurring as part of the discovery state 204. A potential advantage of performing the authentication 214 in the discovery state 204 or early in the connected state 206 is so that a failure to authenticate can limit or eliminate some functionality for a power negotiation in the 206 or the power state 208.

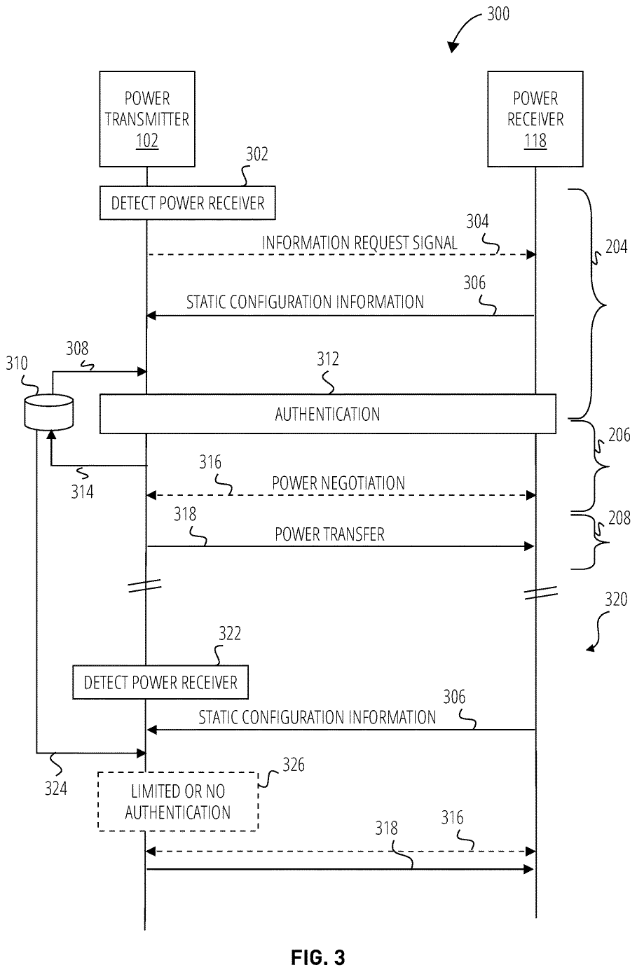

FIG. 3 illustrates a message diagram 300 between a Power Transmitter 102 and a Power Receiver 118 in accordance with some aspects of this disclosure. At block 302, the Power Transmitter 102 detects the Power Receiver. For example, the Power Transmitter 102 might transmit a ping signal and detect a response. Otherwise, the Power Transmitter 102 might detect the Power Receiver 118 based on a change in impedance at the primary coil and establishing communication. Other techniques for detecting the Power Receiver 118 might be possible. Detecting the Power Receiver at block 302 might occur as part of the 204, shown in FIG. 3 for reference.

After detecting the Power Receiver 118, the Power Transmitter 102 obtains static configuration information 306 from the Power Receiver 118. In some implementations, the Power Transmitter 102 transmits an information request signal 304 and receives the static configuration information 306 as a response to the information request signal 304. In some implementations, the Power Transmitter 102 obtains the static configuration information 306 by reading an NFC tag of the Power Receiver 118. The static configuration information 306 includes first identification information, among other data. The first identification information uniquely identifies the Power Receiver 118 from other Power Receivers (not shown).

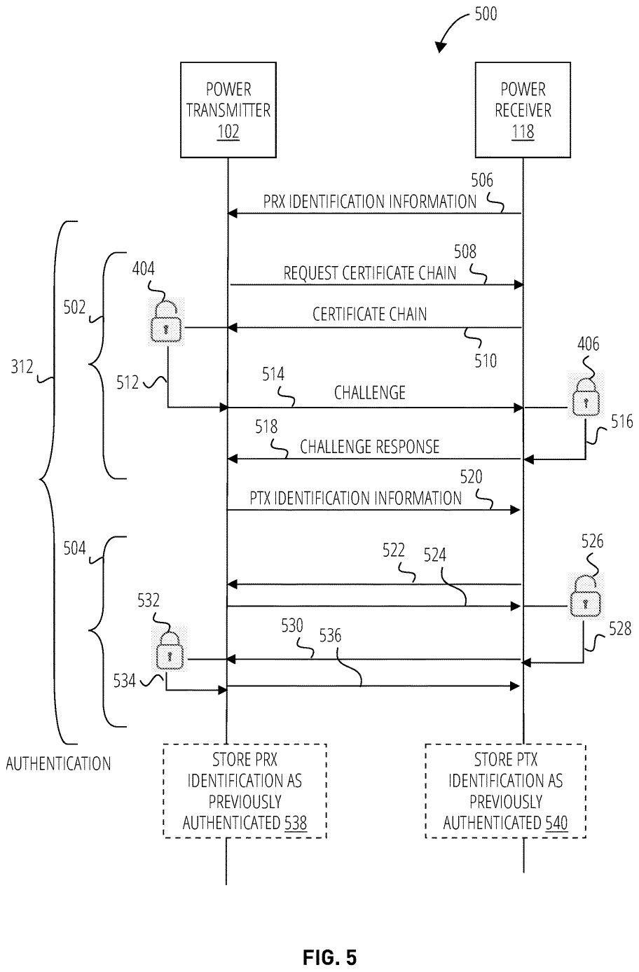

At arrow 308, the Power Transmitter 102 might access a local storage 310 of the Power Transmitter 102 to determine whether the Power Receiver's first identification information is stored in the local storage 310. The local storage 310 includes stored identification information of wireless power apparatuses that have been successfully previously authenticated by the Power Transmitter 102. For example, the stored identification information can include one or more entries with apparatus-specific identification information associated with respective wireless power apparatuses. In this example (top of FIG. 3), the Power Receiver 118 has not been successfully previously authenticated by the Power Transmitter 102, and the first identification information of the Power Receiver 118 might not be stored in the local storage 310. Thus, the Power Transmitter 102 may initiate an authentication 312 of the Power Receiver 118. An example authentication 312 is further described with reference to FIG. 5. Note that the authentication 312 might occur at the end of the discovery state 204, between the discovery state 204 and the connected state 206, or at the beginning of the connected state 206.

After the authentication 312, if the Power Transmitter 102 successfully authenticates the Power Receiver 118, the Power Transmitter 102 stores (shown at arrow 314) the first identification information of the Power Receiver 118 in the local storage 310 for later reference. Continuing with the connected state 206 after successful authentication 312, the Power Transmitter 102 and the Power Receiver 118 optionally perform a power negotiation 316. After moving to the power state 208, the Power Transmitter 102 transmits power transfer 318 to the Power Receiver 118.

The Power Receiver 118 may be removed from the Power Transmitter 102 after the power state 208 and then subsequently placed (perhaps hours, days, weeks, or longer) in proximity to the Power Transmitter 102 at a later time 320. At block 322, the Power Transmitter 102 detects the Power Receiver 118, similar to the techniques described with reference to block 302. The Power Transmitter 102 obtains the static configuration information 306 as described previously. The Power Transmitter 102 retrieves (shown at arrow 324) the stored identification information from the local storage 310. If the first identification information matches at least one entry in the stored identification information, the Power Transmitter 102 might perform limited or no authentication 326 before proceeding with the power negotiation 316 and power transfer 318. In some implementations, the limited or no authentication 326 might include an abbreviated authentication message exchange that has less messaging overhead compared to a full authentication (such as the authentication 312). Alternatively, the limited or no authentication 326 might completely omit an authentication message exchange that would otherwise occur if the first identification information of the Power Receiver 118 were not included in the stored identification information indicating successful previous authentications of various wireless power apparatuses.

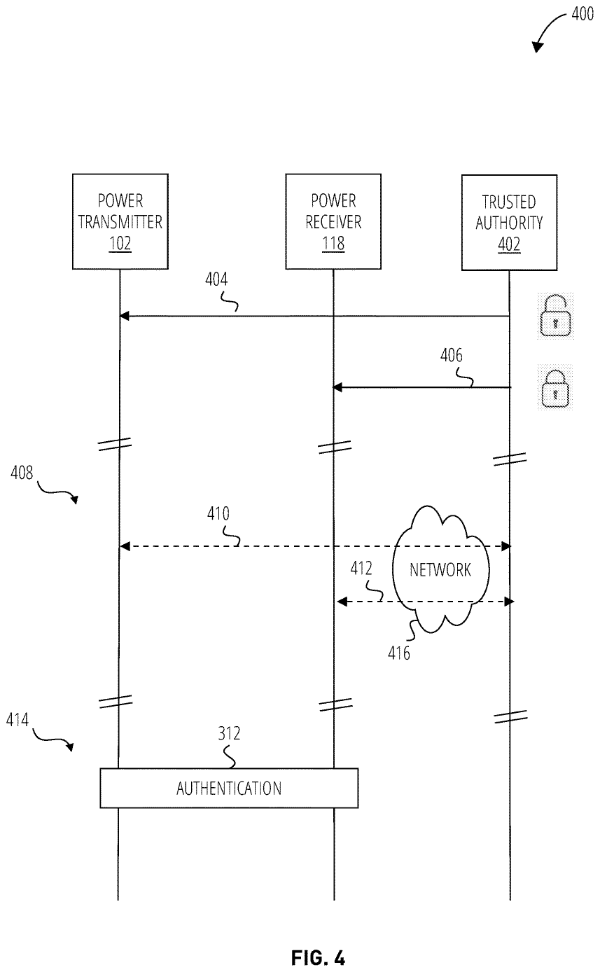

FIG. 4 illustrates a message diagram 400 illustrating PKI-based authentication. The example Power Receiver 118 is certified by a trusted authority 402. The trusted authority 402 might create a public key and a private key associated with the manufacturer or product model of the Power Receiver 118. The public key and the private key might be based on a root public key of the trusted authority 402 such that the public key of the manufacturer or product model can be verified by the root public key 404. The trusted authority 402 can provide the root public key 404 (or the public key associated with the Power Receiver 118) to the Power Transmitter 102. The trusted authority 402 also provides the private key 406 to a manufacturer of the Power Receiver 118 and the manufacturer can securely store the private key in the Power Receiver 118. Although FIG. 4 only illustrates the private key 406 for the Power Receiver 118, the trusted authority 402 also can generate and provide a different public/private key pair associated with the Power Transmitter 102. Authentication information refers to a wireless power apparatus' private key and the public key or root public key.

In some implementations, the wireless power apparatus can communicate with the trusted authority 402 via a network 416. Thus, FIG. 4 shows optional capability 408 for an authentication information update 410 or authentication information update 412 by the Power Transmitter 102 and Power Receiver 118, respectively. In some implementations, when an authentication fails, a wireless power apparatus can access the trusted authority 402 via a network 416 to obtain updated authentication information before reattempting the authentication. Furthermore, in some implementations, the authentication information can include revocation data (such as a list of revoked public/private keys) or explicit permission (such as indentation information for trusted wireless power apparatuses that do not require authentication). In some implementations, the authentication information can include or refer to algorithms for verifying a public/private key pair.

After obtaining the root public key 404 from the trusted authority 402, the Power Transmitter 102 can use the root public key 404 in an authentication 312 (such as PKI-based authentication) of the Power Receiver 118.

FIG. 5 illustrates an example authentication 312 between the Power Transmitter 102 and the Power Receiver 118. The authentication 312 might be a bi-directional authentication in which a first part 502 enables the Power Transmitter 102 to authenticate the Power Receiver 118 and a second part 504 enables the Power Receiver 118 to authenticate the Power Transmitter 102. The order of the first part 502 and the second part 504 can be reversed in some implementations. Furthermore, some example authentications 312 might include only one of the first part 502 or the second part 504.

The first part 502 describes messaging in which the Power Transmitter 102 authenticates the Power Receiver 118 using a PKI-based authentication after the Power Receiver 118 provides first identification information (of the PRx) 506 to the Power Transmitter 102. The Power Transmitter 102 transmits a first message 508 to request a certificate chain digest from the Power Receiver 118. In a second message 510, the Power Receiver 118 communicates the certificate chain digest to the Power Transmitter 102. The Power Transmitter 102 can verify 512 the certificate chain digest using the root public key 404. The Power Transmitter 102 transmits a third message 514 to the Power Receiver 118. The third message 514 can be referred to as a challenge. For example, the challenge can include a nonce (such as a random string). The nonce might be encrypted using the public key of the Power Receiver 118. The Power Receiver 118 can decrypt 516 the challenge and sign a response based on the decrypted nonce its private key 406. A fourth message 518 can be referred to as a challenge response. The Power Transmitter 102 can decrypt and verify the challenge response based on a comparison to the originally transmitted challenge.

The second part 504 might use the same authentication messaging as the first part 502 except in reverse. For example, messages and procedures 522, 524, 528, 530, 534, and 536 are similar to their counterparts described in messages and procedures 508, 510, 512, 514, 516, and 518 except in the reverse direction and using the private key 532 of the Power Transmitter 102 and the public key 526 of the Power Receiver 118. Furthermore, the Power Transmitter 102 might provide second identification information (of the PTx) 520 to the Power Receiver 118 so that the Power Receiver 118 can remember the Power Transmitter 102 after the Power Transmitter 102 has been successfully authenticated in the second part 504.

In the example shown in FIG. 5, both the Power Transmitter 102 and the Power Receiver 118 successfully authenticate the other wireless power apparatus in the bi-directional authentication 312. At block 538, the Power Transmitter 102 might store the first identification (of the PRx) in a local memory of the Power Transmitter 102. The local memory of the Power Transmitter 102 might be configured to retain stored identification information for successfully previously authenticated wireless power apparatuses 538. Similarly, at block 540, the Power Receiver 118 might store the second identification information (of the PTx) in a local memory of the Power Receiver 118. The local memory of the Power Receiver 118 includes stored identification information for successfully previously authenticated wireless power apparatuses.

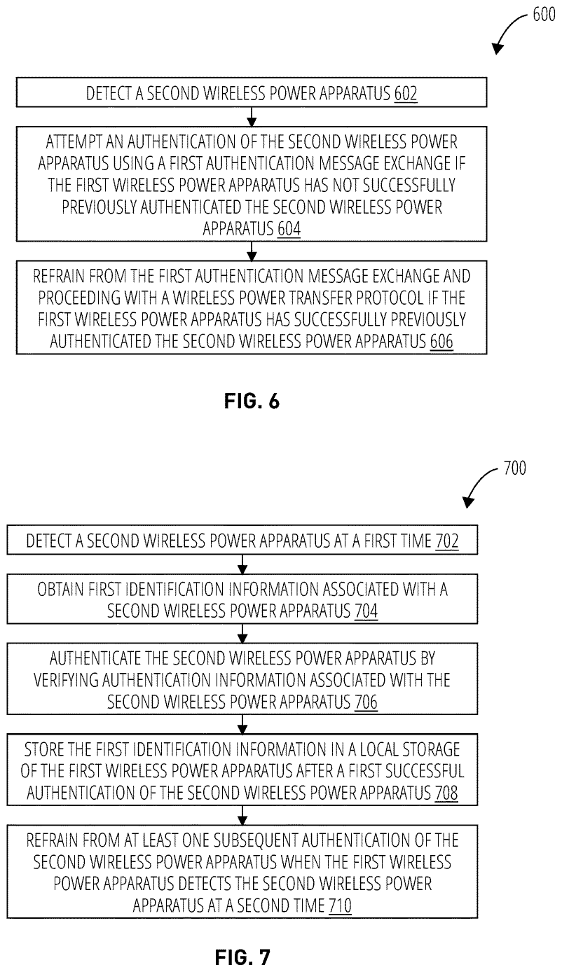

FIG. 6 illustrates a flow chart 600 with example operations of a first wireless power apparatus in accordance with some aspects of this disclosure. For example, the flow chart 600 might be performed by the Power Transmitter 102 or the Power Receiver 118 described with reference to other Figures of this disclosure. In block 602, the first wireless power apparatus detects a second wireless power apparatus. In block 604, the first wireless power apparatus attempts an authentication of the second wireless power apparatus using a first authentication message exchange if the first wireless power apparatus has not successfully previously authenticated the second wireless power apparatus. In block 606, the first wireless power apparatus refrains from the first authentication message exchange and proceeding with a wireless power transfer protocol if the first wireless power apparatus has successfully previously authenticated the second wireless power apparatus.

FIG. 7 illustrates another flow chart 700 with example operations of a first wireless power apparatus in accordance with some aspects of this disclosure. For example, the flow chart 700 might be performed by the Power Transmitter 102 or the Power Receiver 118 described with reference to other Figures of this disclosure. In block 702, the first wireless power apparatus detects a second wireless power apparatus at a first time. In block 704, the first wireless power apparatus obtains first identification information associated with a second wireless power apparatus. In block 706, the first wireless power apparatus authenticates the second wireless power apparatus by verifying authentication information associated with the second wireless power apparatus. In block 708, the first wireless power apparatus stores the first identification information in a local storage of the first wireless power apparatus after a first successful authentication of the second wireless power apparatus. In block 710, the first wireless power apparatus refrains from at least one subsequent authentication of the second wireless power apparatus when the first wireless power apparatus detects the second wireless power apparatus at a second time.

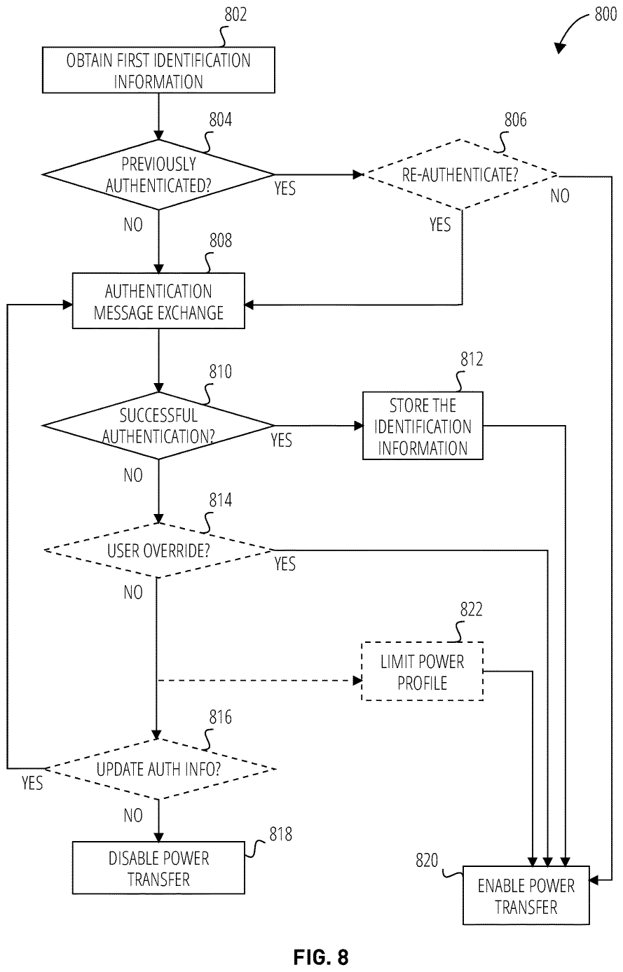

FIG. 8 illustrates a flow chart 800 with example operations of a first wireless power apparatus in accordance with some aspects of this disclosure. For example, the flow chart 700 might be performed by the Power Transmitter 102 or the Power Receiver 118 described with reference to other Figures of this disclosure. FIG. 8 also illustrates some example error handling in the event that an authentication fails. Although the example flow chart 800 depicts a particular sequence of operations, the sequence may be altered without departing from the scope of the present disclosure. For example, some of the operations depicted may be performed in parallel or in a different sequence that does not materially affect the function of the flow chart 800. In other examples, different components of an example device or system that implements the flow chart 800 may perform functions at substantially the same time or in a specific sequence. Furthermore, some implementations of the disclosed subject matter might include fewer or more features than described with reference to FIG. 8.

At block 802, the first wireless power apparatus obtains first identification information associated with a second wireless power apparatus. At block 804, the first wireless power apparatus determines whether the second wireless power apparatus has successfully previously authenticated. For example, the first wireless power apparatus can compare the first identification information of the second wireless power apparatus with a local storage having stored authentication information for previously authenticated wireless power apparatuses. If the first identification information is included in the stored identification information, the first wireless power apparatus can determine that the second wireless power apparatus has been successfully previously authenticated. Otherwise, the first wireless power apparatus can determine that the second wireless power apparatus has not successfully previously authenticated. If, at decision block 804, the first wireless power apparatus determines that the second wireless power apparatus previously authenticated, the flow chart 800 continues to block 806. Otherwise, the flow chart 800 proceeds to block 808 to perform an authentication of the second wireless power apparatus. At block 808, the authentication includes an authentication message exchange, such as the PKI-based authentication described with reference to FIG. 5. At decision block 810, if the authentication is successful, the flow chart 800 continues to block 812 where the first wireless power apparatus stores the first identification information of the second wireless power apparatus in a local storage of the first wireless power apparatus and continues to block 820. At block 820, because the authentication was successful, the first wireless power apparatus enables power transfer to occur between the first wireless power apparatus and the second wireless power apparatus. The first wireless power apparatus can continue with a wireless power transfer protocol (such as described with reference to FIG. 2), including connected state and/or power state.

Returning to decision block 810, if the authentication fails (meaning the first wireless power apparatus is unsuccessful in authenticating the second wireless power apparatus), the first wireless power apparatus might take one or more steps to mitigate the failed authentication. For example, at decision block 814, if the first wireless power apparatus presents an error message and receives a user override to proceed with wireless power transfer despite the failed authentication, the flow chart 800 can proceed to block 820 (enable power transfer). In some implementations, after a failed authentication, the first wireless power apparatus might implement a limitation (such as a maximum power rating) that the first wireless power apparatus will support for the unauthenticated second wireless power apparatus. Shown at optional block 822, the first wireless power apparatus can limit the power profile or other setting for the second wireless power apparatus before proceeding to block 820 to enable power transfer at the limited power profile. As an example, the limited power profile might support a maximum power (such as 5 Watts (W), 15 W, or other value) that is below a threshold power rating capable of damaging the first wireless power apparatus or the second wireless power apparatus.

In another example, when the authentication fails at decision block 810, the first wireless power apparatus might update its authentication information via a network communication (if available) and reattempt the authentication at block 808. If the authentication information has not been updated or the first wireless power apparatus is unable to obtain updated authentication information, the flow chart 800 might proceed to block 818. At block 818, the first wireless power apparatus disables the power transfer to the second wireless power apparatus due to a failure of the authentication and optionally one or more mitigation actions described with reference to blocks 814, 822, and 816.

The flow chart 800 also describes an optional implementation in which the first wireless power apparatus might occasionally reauthenticate the second wireless power apparatus. For example, at block 804 after determining that the second wireless power apparatus has previously authenticated, the flow chart 800 might proceed to decision block 806. At decision block 806, the first wireless power apparatus might decide whether to reauthenticate the second wireless power apparatus. There may be various conditions in which the first wireless power apparatus decides to reauthenticate the second wireless power apparatus. For example, if the previous authentication occurred more than a threshold period prior to the current time, the previous authentication might be considered stale and the first wireless power apparatus might decide to reauthenticate. Thus, in some implementations, the local storage also might store a timestamp or timing information associated with a previous authentication of each previously authenticated wireless power apparatuses. Alternatively, or additionally, the first wireless power apparatus might randomly perform a reauthentication for a subset of times that it detects the second wireless power apparatus in the discovery state. Alternatively, or additionally, the first wireless power apparatus might periodically perform a reauthentication each nth time that it detects the second wireless power apparatus in the discovery state, where n is a predetermined value (such as 10, 15, or 25, among other examples). For any condition in which the first wireless power apparatus decides, at decision block 806 to reauthenticate the second wireless power apparatus, the flow chart 800 proceeds to block 808. Otherwise, the flow chart 800 proceeds to block 820.

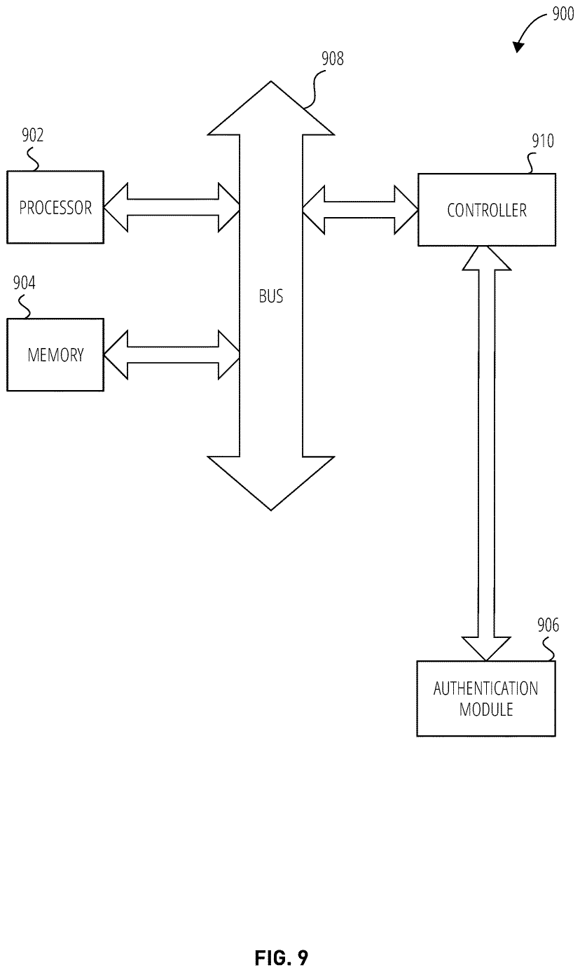

FIG. 9 illustrates a block diagram of an example apparatus for use in a wireless power system. In some implementations, the apparatus 900 may be a first wireless power apparatus (such as the Power Transmitter 102 or the Power Receiver 118) described herein. The apparatus 900 can include a processor 902 (possibly including multiple processors, multiple cores, multiple nodes, or implementing multi-threading, etc.). The apparatus 900 also can include a memory 904. The memory 904 may be system memory or any one or more of the possible realizations of computer-readable media described herein. The apparatus 900 also can include a bus 908 (such as PCI, ISA, PCI-Express, HyperTransport®, InfiniBand®, NuBus,® AHB, AXI, etc.).

The apparatus 900 may include one or more controllers 910. In some implementations, the controller 910 can be distributed within the processor 902, the memory 904, and the bus 908. The controller 910 may perform some or all of the operations described herein. For example, the controller 910 may implement the processes described with reference to any one of FIG. 2 through FIG. 8, or any combination thereof.

The memory 904 can include computer instructions executable by the processor 902 to implement the functionality of the implementations described herein. Any one of these functionalities may be partially (or entirely) implemented in hardware or on the processor 902. For example, the functionality may be implemented with an application specific integrated circuit, in logic implemented in the processor 902, in a co-processor on a peripheral device or card, etc. Further, realizations may include fewer or additional components not illustrated in FIG. 9. The processor 902, the memory 904, and the controller 910 may be coupled to the bus 906. Although illustrated as being coupled to the controller 910, the memory 904 may be coupled to the processor 902.

The apparatus 900 also includes an authentication module 906. The authentication module 906 might store authentication information (such as public keys, root public key, or a private key of the apparatus 900). The authentication module 906 may implement the processes described with reference to any one of FIG. 2 through FIG. 8, or any combination thereof. The authentication module 906 might include a local storage to maintaining IDs of previously authenticated wireless power apparatuses.

FIG. 1 through FIG. 9 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (identified as clauses for reference).

### Clauses

Clause 1. A method performed by a first wireless power apparatus, including: detecting a second wireless power apparatus; attempting an authentication of the second wireless power apparatus using a first authentication message exchange if the first wireless power apparatus has not successfully previously authenticated the second wireless power apparatus; and refraining from the first authentication message exchange and proceeding with a wireless power transfer protocol if the first wireless power apparatus has successfully previously authenticated the second wireless power apparatus.

Clause 2. The method of clause 1, further including: obtaining first identification information associated with a second wireless power apparatus; and determining whether the first wireless power apparatus has successfully previously authenticated the second wireless power apparatus based, at least in part, on the first identification information.

Clause 3. The method of clause 2, further including: maintaining a local storage having stored identification information associated with wireless power apparatuses that have been successfully previously authenticated by the first wireless power apparatus, where determining whether the first wireless power apparatus has successfully previously authenticated the second wireless power apparatus includes: determining that the first wireless power apparatus has not successfully previously authenticated the second wireless power apparatus when the stored identification information does not include the first identification information, and determining that the first wireless power apparatus has successfully previously authenticated the second wireless power apparatus when the stored identification information includes the first identification information.

Clause 4. The method of any one of clauses 1 to 3, further including, after successfully previously authenticating the second wireless power apparatus at a first time: detecting the second wireless power apparatus at a second time; determining that the first wireless power apparatus has successfully previously authenticated the second wireless power apparatus at the first time; and refraining from the first authentication message exchange if the second time is within a threshold period that follows the first time.

Clause 5. The method of clause 4, further including: attempting a reauthentication of the second wireless power apparatus if the second time occurs after the threshold period.

Clause 6. The method of any one of clauses 1 to 5, where refraining from the first authentication message exchange includes: attempting the authentication of the second wireless power apparatus using an abbreviated authentication message exchange if the first wireless power apparatus has successfully previously authenticated the second wireless power apparatus, where the abbreviated authentication message exchange has fewer message exchanges than the first authentication message exchange.

Clause 7. The method of any one of clauses 1 to 6, further including: randomly attempting a reauthentication of the second wireless power apparatus after detecting the second wireless power apparatus at different times following periods in which the first wireless power apparatus does not detect the second wireless power apparatus.

Clause 8. The method of clause 7, where the reauthentication includes a second authentication message exchange that is different from the first authentication message exchange.

Clause 9. The method of any one of clauses 1 to 8, further including: implementing a limitation for wireless power transfer to the second wireless power apparatus when the second wireless power apparatus fails to authenticate.

Clause 10. The method of clause 9, where said implementing the limitation includes: presenting an error indication via a user interface of the first wireless power apparatus or the second wireless power apparatus; disabling the wireless power transfer to the second wireless power apparatus; limiting the wireless power transfer to a maximum power rating; or any combination thereof.

Clause 11. The method of clause 9 or 10, further including: receiving a user override after implementing the limitation; and permitting the wireless power transfer without the limitation in response to receiving the user override.

Clause 12. The method of any one of clauses 1 to 11, further including, if the second wireless power apparatus fails to authenticate after attempting the authentication: obtaining updated authentication information via a network; and reattempting the authentication using the first authentication message exchange and the updated authentication information.

Clause 13. The method of any one of clauses 1 to 12, where the first wireless power apparatus is one of a Power Transmitter or a Power Receiver, and where the second wireless power apparatus is the other one of the Power Transmitter or the Power Receiver.

Clause 14. A method performed by a first wireless power apparatus, including: detecting a second wireless power apparatus at a first time; obtaining first identification information associated with a second wireless power apparatus; authenticating the second wireless power apparatus by verifying authentication information associated with the second wireless power apparatus; storing the first identification information in a local storage of the first wireless power apparatus after a first successful authentication of the second wireless power apparatus; refraining from at least one subsequent authentication of the second wireless power apparatus when the first wireless power apparatus detects the second wireless power apparatus at a second time.

Clause 15. The method of clause 14, further including: maintaining the local storage configured to retain stored identification information associated with wireless power apparatuses that have been successfully previously authenticated by the first wireless power apparatus, where refraining from the at least one subsequent authentication of the second wireless power apparatus includes skipping the at least one subsequent authentication if the stored identification information includes the first identification information.

Clause 16. The method of clause 14 or 15, where authenticating the second wireless power apparatus includes: obtaining a certificate digest from the second wireless power apparatus as part of an authentication message exchange; verifying the certificate digest using a root public key; communicating a challenge as part of the first authentication message exchange; receiving a response from the second wireless power apparatus, and verifying the response using public key infrastructure (PKI)-based authentication.

Clause 17. A first wireless power apparatus, including: a power transfer coil configured to transmit or receive wireless power from a second wireless power apparatus; and a controller configured to: detect a second wireless power apparatus, attempt an authentication of the second wireless power apparatus using a first authentication message exchange if the first wireless power apparatus has not successfully previously authenticated the second wireless power apparatus, and refrain from the first authentication message exchange and proceeding with a wireless power transfer protocol if the first wireless power apparatus has successfully previously authenticated the second wireless power apparatus.

Clause 18. The first wireless power apparatus of clause 17, where the controller is further configured to: obtain first identification information associated with a second wireless power apparatus; and determine whether the first wireless power apparatus has successfully previously authenticated the second wireless power apparatus based, at least in part, on the first identification information.

Clause 19. The first wireless power apparatus of clause 17 or 18, where the controller is further configured: maintain a local storage having stored identification information associated with wireless power apparatuses that have been successfully previously authenticated by the first wireless power apparatus; determine that the first wireless power apparatus has not successfully previously authenticated the second wireless power apparatus when the stored identification information does not include the first identification information; and determine that the first wireless power apparatus has successfully previously authenticated the second wireless power apparatus when the stored identification information includes the first identification information.

Clause 20. The first wireless power apparatus of any one of clauses 17 to 19, where the controller is further configured to, after successfully previously authenticate the second wireless power apparatus at a first time: detect the second wireless power apparatus at a second time; determine that the first wireless power apparatus has successfully previously authenticated the second wireless power apparatus at the first time; and refrain from the first authentication message exchange if the second time is within a threshold period that follows the first time.

Clause 21. The first wireless power apparatus of clause 20, where the controller is further configured: attempt a reauthentication of the second wireless power apparatus if the second time occurs after the threshold period.

Clause 22. The first wireless power apparatus of any one of clauses 17 to 21, where the controller being configured to refrain from the first authentication message exchange includes the controller being configured to: attempt the authentication of the second wireless power apparatus using an abbreviated authentication message exchange if the first wireless power apparatus has successfully previously authenticated the second wireless power apparatus, where the abbreviated authentication message exchange has fewer message exchanges than the first authentication message exchange.

Clause 23. The first wireless power apparatus of any one of clauses 17 to 22, where the controller is further configured to: randomly attempt a reauthentication of the second wireless power apparatus after detecting the second wireless power apparatus at different times following periods in which the first wireless power apparatus does not detect the second wireless power apparatus.

Clause 24. The first wireless power apparatus of clause 23, where the reauthentication includes a second authentication message exchange that is different from the first authentication message exchange.

Clause 25. The first wireless power apparatus of any one of clauses 17 to 24, where the controller is further configured to: implement a limitation for wireless power transfer to the second wireless power apparatus when the second wireless power apparatus fails to authenticate.

Clause 26. The first wireless power apparatus of clause 25, where the controller is further configured implement the limitation by: presenting an error indication via a user interface of the first wireless power apparatus or the second wireless power apparatus; disabling the wireless power transfer to the second wireless power apparatus; limiting the wireless power transfer to a maximum power rating; or any combination thereof.

Clause 27. The first wireless power apparatus of clause 25 or 26, where the controller is further configured to: receive a user override after implementing the limitation; and permit the wireless power transfer without the limitation in response to receiving the user override.

Clause 28. The first wireless power apparatus of any one of clauses 17 to 27, where the controller is further configured to, if the second wireless power apparatus fails to authenticate after attempting the authentication: obtain updated authentication information via a network; and reattempt the authentication using the first authentication message exchange and the updated authentication information.

Clause 29. The first wireless power apparatus of any one of clauses 17 to 28, where the first wireless power apparatus is one of a Power Transmitter or a Power Receiver, and where the second wireless power apparatus is the other one of the Power Transmitter or the Power Receiver.

Clause 30. The first wireless power apparatus of any one of clauses 17 to 29, further including: a secure memory for storing authentication information.

Clause 31. The first wireless power apparatus of clause 30, where the authentication information includes at least one private associated with first wireless power apparatus and at least one root public key issued by a trusted authority.

Clause 32. The first wireless power apparatus of clause 30 or 31, where the secure memory is securely integrated, attached, or affixed to the first wireless power apparatus.

Clause 33. A first wireless power apparatus including: a power transfer coil configured to transmit or receive wireless power from a second wireless power apparatus; and a controller configured to: detect a second wireless power apparatus at a first time; obtain first identification information associated with a second wireless power apparatus; authenticate the second wireless power apparatus by verifying authentication information associated with the second wireless power apparatus; store the first identification information in a local storage of the first wireless power apparatus after a first successful authentication of the second wireless power apparatus; refrain from at least one subsequent authentication of the second wireless power apparatus when the first wireless power apparatus detects the second wireless power apparatus at a second time.

Clause 34. The first wireless power apparatus of clause 33, where the controller is configured to: maintain the local storage configured to retain stored identification information associated with wireless power apparatuses that have been successfully previously authenticated by the first wireless power apparatus, where refraining from the at least one subsequent authentication of the second wireless power apparatus includes skip the at least one subsequent authentication if the stored identification information includes the first identification information.

Another innovative aspect of the subject matter described in this disclosure can be implemented as a computer-readable medium having stored therein instructions which, when executed by a processor, causes the processor to perform any one of the above-mentioned functionalities.

Another innovative aspect of the subject matter described in this disclosure can be implemented as a system having means for implementing any one of the above-mentioned functionalities.

Another innovative aspect of the subject matter described in this disclosure can be implemented as an apparatus having one or more processors configured to perform one or more operations from any one of the above-mentioned methods.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method performed by a first wireless power apparatus, comprising:
detecting a second wireless power apparatus;
obtaining first identification information associated with a second wireless power apparatus;
comparing the first identification information with stored identification information associated with wireless power apparatuses that have been successfully previously authenticated by the first wireless power apparatus;
attempting an authentication of the second wireless power apparatus using a first authentication message exchange when the stored identification information includes first identification information; and
attempting the authentication of the second wireless power apparatus using an abbreviated authentication message exchange when the stored identification information does not include the first identification information, wherein the abbreviated authentication message exchange has fewer message exchanges than the first authentication message exchange.

2. (canceled)

3. The method of claim 1, further comprising:
maintaining a local storage having the stored identification information associated with the wireless power apparatuses that have been successfully previously authenticated by the first wireless power apparatus;
determining that the first wireless power apparatus has not successfully previously authenticated the second wireless power apparatus when the stored identification information does not include the first identification information, and
determining that the first wireless power apparatus has successfully previously authenticated the second wireless power apparatus when the stored identification information includes the first identification information.

4. The method of claim 1, further comprising, after successfully previously authenticating the second wireless power apparatus at a first time:
detecting the second wireless power apparatus at a second time;
refraining from the first authentication message exchange if the second time is within a threshold period that follows the first time; and
attempting a reauthentication of the second wireless power apparatus if the second time occurs after the threshold period.

5-6. (canceled)

7. The method of claim 1, further comprising:
randomly attempting a reauthentication of the second wireless power apparatus after detecting the second wireless power apparatus at different times following periods in which the first wireless power apparatus does not detect the second wireless power apparatus.

8. The method of claim 7, wherein the reauthentication includes a second authentication message exchange that is different from the first authentication message exchange.

9. The method of claim 1, further comprising:
limiting or disabling wireless power transfer to the second wireless power apparatus to a maximum power rating when the second wireless power apparatus fails to authenticate.

10. The method of claim 9, further comprising:
presenting an error indication via a user interface of the first wireless power apparatus or the second wireless power apparatus.

11. The method of claim 9, further comprising, after limiting or disabling the wireless power transfer:
receiving a user override after implementing the limitation; and
permitting the wireless power transfer in response to receiving the user override.

12. The method of claim 1, further comprising:
obtaining updated authentication information via a network; and
reattempting the authentication using the first authentication message exchange and the updated authentication information.

13. (canceled)

14. A method performed by a first wireless power apparatus, comprising:
detecting a second wireless power apparatus at a first time;
obtaining first identification information associated with a second wireless power apparatus;
authenticating the second wireless power apparatus by verifying authentication information associated with the second wireless power apparatus;
storing the first identification information in a local storage of the first wireless power apparatus after a first successful authentication of the second wireless power apparatus;
refraining from at least one subsequent authentication of the second wireless power apparatus when the first wireless power apparatus detects the second wireless power apparatus at a second time.

15. The method of claim 14, further comprising:
maintaining the local storage configured to retain stored identification information associated with wireless power apparatuses that have been successfully previously authenticated by the first wireless power apparatus,
wherein refraining from the at least one subsequent authentication of the second wireless power apparatus includes skipping the at least one subsequent authentication if the stored identification information includes the first identification information.

16. The method of claim 14, wherein authenticating the second wireless power apparatus includes:
obtaining a certificate digest from the second wireless power apparatus as part of an authentication message exchange;
verifying the certificate digest using a root public key;
communicating a challenge as part of the first authentication message exchange;
receiving a response from the second wireless power apparatus, and verifying the response using public key infrastructure (PKI)-based authentication.

17. A first wireless power apparatus, comprising:
a power transfer coil configured to transmit or receive wireless power from a second wireless power apparatus; and
a controller configured to:
detect a second wireless power apparatus,
obtain first identification information associated with a second wireless power apparatus,
compare the first identification information with stored identification information associated with wireless power apparatuses that have been successfully previously authenticated by the first wireless power apparatus,
attempt an authentication of the second wireless power apparatus using a first authentication message exchange when the stored identification information includes first identification information, and
attempt the authentication of the second wireless power apparatus using an abbreviated authentication message exchange when the stored identification information does not include the first identification information, wherein the abbreviated authentication message exchange has fewer message exchanges than the first authentication message exchange.

18. (canceled)

19. The first wireless power apparatus of claim 17, wherein the controller is further configured:
maintain a local storage having stored identification information associated with wireless power apparatuses that have been successfully previously authenticated by the first wireless power apparatus;
determine that the first wireless power apparatus has not successfully previously authenticated the second wireless power apparatus when the stored identification information does not include the first identification information; and
determine that the first wireless power apparatus has successfully previously authenticated the second wireless power apparatus when the stored identification information includes the first identification information.

20. The first wireless power apparatus of claim 17, wherein the controller is further configured to, after successfully previously authenticate the second wireless power apparatus at a first time:
detect the second wireless power apparatus at a second time;
refrain from the first authentication message exchange if the second time is within a threshold period that follows the first time and
attempt a reauthentication of the second wireless power apparatus if the second time occurs after the threshold period.

21-22. (canceled)

23. The first wireless power apparatus of claim 17, wherein the controller is further configured to:
randomly attempt a reauthentication of the second wireless power apparatus after detecting the second wireless power apparatus at different times following periods in which the first wireless power apparatus does not detect the second wireless power apparatus, wherein the reauthentication includes a second authentication message exchange that is different from the first authentication message exchange.

24. (canceled)

25. The first wireless power apparatus of claim 17, wherein the controller is further configured to:
limit or disable wireless power transfer to the second wireless power apparatus when the second wireless power apparatus fails to authenticate.

26-27. (canceled)

28. The first wireless power apparatus of claim 17, wherein the controller is further configured to, if the second wireless power apparatus fails to authenticate after attempting the authentication:
obtain updated authentication information via a network; and
reattempt the authentication using the first authentication message exchange and the updated authentication information.

29. (canceled)

30. The first wireless power apparatus of claim 17, further comprising:
a secure memory for storing authentication information, wherein the secure memory is securely integrated, attached, or affixed to the first wireless power apparatus.

31. The first wireless power apparatus of claim 30, wherein the authentication information includes at least one private associated with first wireless power apparatus and at least one root public key issued by a trusted authority.

32-34. (canceled)
